(19) United States
(12) Patent Application Publication
(10) Pub. No.: US 2005/0145633 A1
(43) Pub. Date: Jul. 7, 2005

(54) Heat-insulating cooking container

(75) Inventors: Takashi Goto, Niigata-ken (JP); Ikuo Miura, Niigata-ken (JP)

Correspondence Address: AKERMAN SENTERFITT, P.O. BOX 3188, WEST PALM BEACH, FL, 33402-3188, US

(73) Assignee: Thermos K.K., Niigata-ken (JP)

(21) Appl. No.: 11/023,079

(22) Filed: Dec. 27, 2004

(30) Foreign Application Priority Data
Jan. 5, 2004 (JP) JP 2004-000240

(51) Int. Cl. A47J 37/01; A47J 9/00; A47J 36/00

(52) U.S. Cl. 220/573.4; 99/342

(57) ABSTRACT

The present invention relates to a heat-insulating cooking container comprising: a heat-insulating outer container and an inner container having an inner-container cover, the inner container being accommodated in the heat-insulating outer container, an aperture portion of the heat-insulating outer container being openably and closably covered by a heat-insulating-outer-container cover, wherein: a thermometer is installed on the heat-insulating-outer-container cover; a temperature-sensing member of the thermometer unit is located on an interior-surface side of the heat-insulating-outer-container cover; and the inner-container cover covers the temperature-sensing member upon opening the heat-insulating-outer-container cover and placing the inner-container cover on an interior surface of the heat-insulating-outer-container cover.

### BACKGROUND OF THE INVENTION

1. Field of the Invention

The present invention relates to a heat-insulating cooking container comprising a heat-insulating outer container and an inner container having an inner-container cover, wherein the inner container is accommodated in the heat-insulating outer container, and an aperture portion of the heat-insulating outer container is openably and closably covered by a heat-insulating-outer-container cover.

2. Description of the Related Art

Japanese registered utility model publication No. 2561080 discloses a conventional heat-insulating cooking container which comprises: a heat-insulating container with an aperture; a cooking pot to be accommodated in the heat-insulating container; a heat-insulating outer cover arranged to open or close the aperture of the heat-insulating container via a hinge and formed with an installation hole; an inner cover provided on an aperture of the cooking pot; a temperature-sensing member installed into the installation hole and downwardly protruding from a bottom surface of the outer cover so as to face the inner cover; and a temperature gauge having a display member provided on an exterior surface of the heat-insulating-outer cover.

In the conventional technique, however, since a sensing member of the temperature gage is exposed to the outer air when the heat-insulating outer cover is opened, temperature detected by the temperature gauge falls, and thus a re-measurement of temperature can not be carried out in a short time even if a user puts the heat-insulating-outer cover on the aperture of the heat-insulating container in order to measure temperature. Accordingly, there is a problem that the measurement of temperature in the interior of the heat-insulating container takes a long time.

### SUMMARY OF THE INVENTION

The present invention has been made to solve the above problem. It is, accordingly, an object of the present invention to provide a heat-insulating cooking container which can prevent a temperature-sensing member from being exposed to the outer air when a heat-insulating-outer-container cover is opened so that temperature detected by a thermometer unit can be prevented from falling, thereby enabling a user to measure temperature in a space defined by a heat-insulating outer container and the cover thereof in a short time when a re-measurement thereof is carried out with the heat-insulating-outer-container cover closed.

In order to attain the above object, according to a first aspect of the present invention, there is provided a heat-insulating cooking container which comprises a heat-insulating outer container and an inner container having an inner-container cover, the inner container being accommodated in the heat-insulating outer container, an aperture portion of the heat-insulating outer container being openably and closably covered by a heat-insulating-outer-container cover, wherein: a thermometer unit is installed on the heat-insulating-outer-container cover; a temperature-sensing member of the thermometer unit is located on an interior-surface side of the heat-insulating-outer-container cover; and the inner-container cover covers the temperature-sensing member upon opening the heat-insulating-outer-container cover and placing the inner-container cover on an interior surface of the heat-insulating-outer-container cover.

By employing this structure, when the heat-insulating-outer-container cover is opened and the inner-container cover is placed on the interior surface of the heat-insulating-outer-container cover, the inner-container cover covers the temperature-sensing member, and thus the temperature-sensing member is prevented from being exposed to the outer air. Accordingly, the falling of temperature detected by the thermometer unit can be prevented, thereby enabling the short-time measurement of temperature in a space defined by the heat-insulating outer container and the heat-insulating-outer-container cover when the heat-insulating-outer container cover is put on the heat-insulating outer container again.

Alternatively, in the above heat-insulating cooking container, a holding member may be provided on the interior surface of the heat-insulating-outer-container cover; and the inner-container cover may be placed on the interior surface of the heat-insulating-outer-container cover with the holding member used.

Moreover, the holding member may be formed in an arc shape, an interior side thereof being to be engaged with the inner-container cover.

Further, in the above heat-insulating cooking container, a space may be provided in between the interior surface of the heat-insulating-outer-container cover and the inner-container cover upon opening the heat-insulating-outer-container cover and placing the inner-container cover on the interior surface of the heat-insulating-outer-container cover.

Still further, in the above heat-insulating cooking container, the interior surface of the inner-container cover may be formed in a plane shape, or a central portion thereof may be concaved toward an upper surface thereof with the interior surface of said heat-insulating-outer-container cover formed in a shape that a central portion thereof is concaved toward the upper surface thereof, or, the interior surface of the inner-container cover may be formed in a shape that the central portion thereof is concaved toward the upper surface thereof with the interior surface of the heat-insulating-outer-container cover formed in a plane shape.

Moreover, in the above heat-insulating cooking container, a knob may be provided on an upper surface of the inner-container cover; and the knob may be positioned upwardly in a manner that the knob is enabled to be held from an above thereof by a user's fingers upon opening the heat-insulating-outer-container cover and placing the inner-container cover on the interior surface of the heat-insulating-outer-container cover.

### BRIEF DESCRIPTION OF THE DRAWINGS

These objects, other objects and advantages of the present invention will become more apparent upon reading of the following detailed description and the accompanying drawings in which:

FIG. 1 is a plan view illustrating a heat-insulating cooking container according to a preferred embodiment of the present invention;

FIG. 2 is a cross sectional view of the heat-insulating cooking container of FIG. 1 along a line A-A therein;

FIG. 3 is a cross sectional view of the heat-insulating cooking container of FIG. 1 along a line B-B therein;

FIG. 4 is a view for explaining an assembling process of the heat-insulating container of the preferred embodiment of the present invention;

FIG. 5 is a view illustrating a condition that an inner-container cover is placed on a heat-insulating-outer-container cover;

FIG. 6 is a cross sectional view of the heat-insulating cooking container of FIG. 5 along a line C-C therein;

FIG. 7 is a plan view illustrating a thermometer unit according to the preferred embodiment of the present invention;

FIG. 8 is a side view illustrating the thermometer unit according to the preferred embodiment of the present invention;

FIG. 9 is a cross sectional view along a line D-D in FIG. 7;

FIG. 10 is a view illustrating a thermometer unit according to a modified embodiment of the present invention; and

FIG. 11 is a detail view illustrating a temperature-indicating member of the thermometer unit.

### DETAILED DESCRIPTION OF THE PREFERRED EMBODIMENTS

Preferred embodiments of the present invention will now be described in detail with reference to the accompanying drawings.

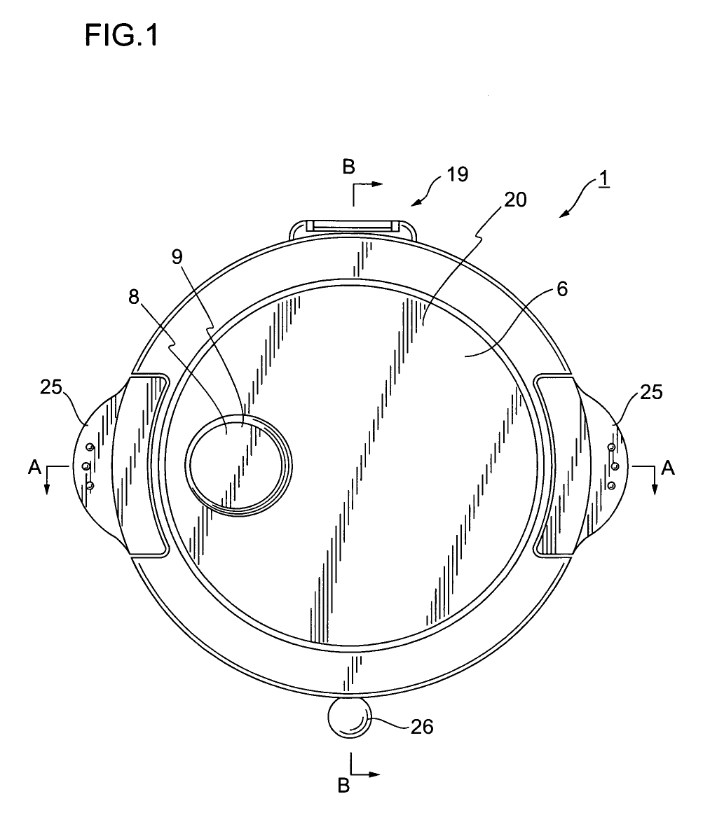

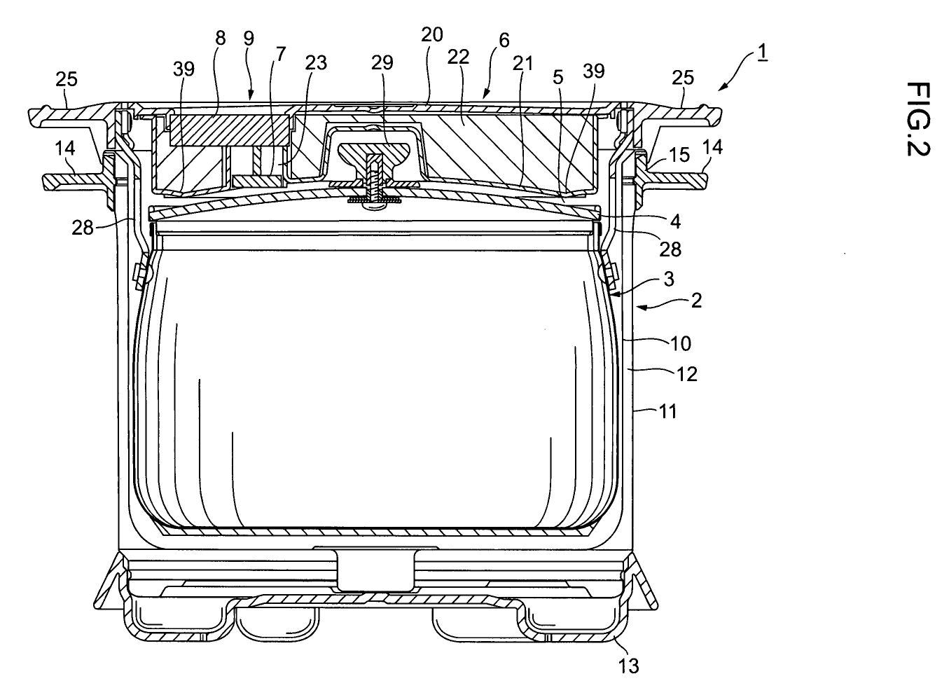

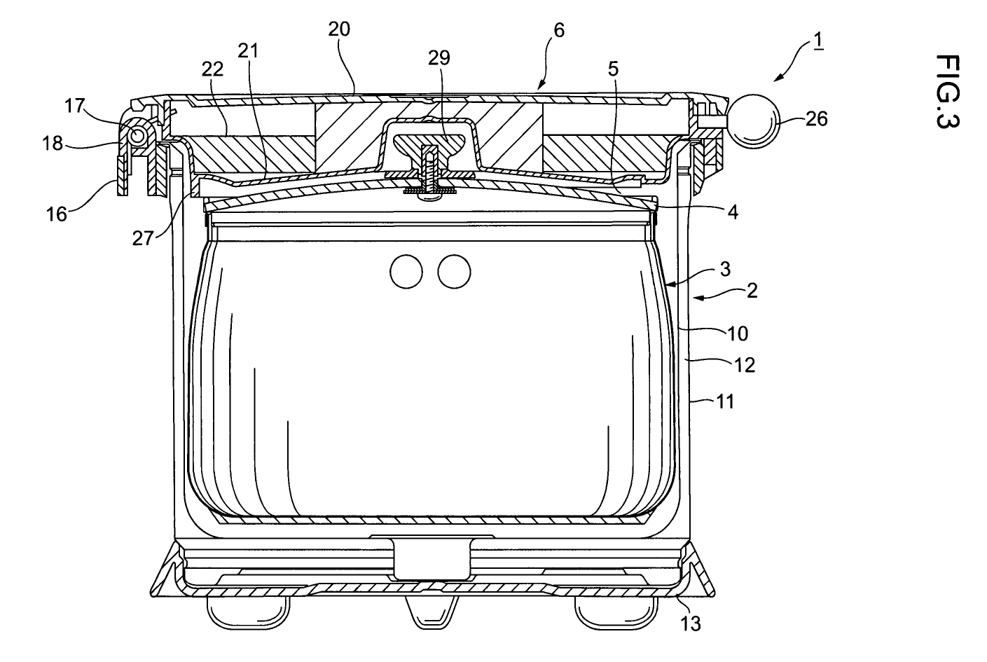

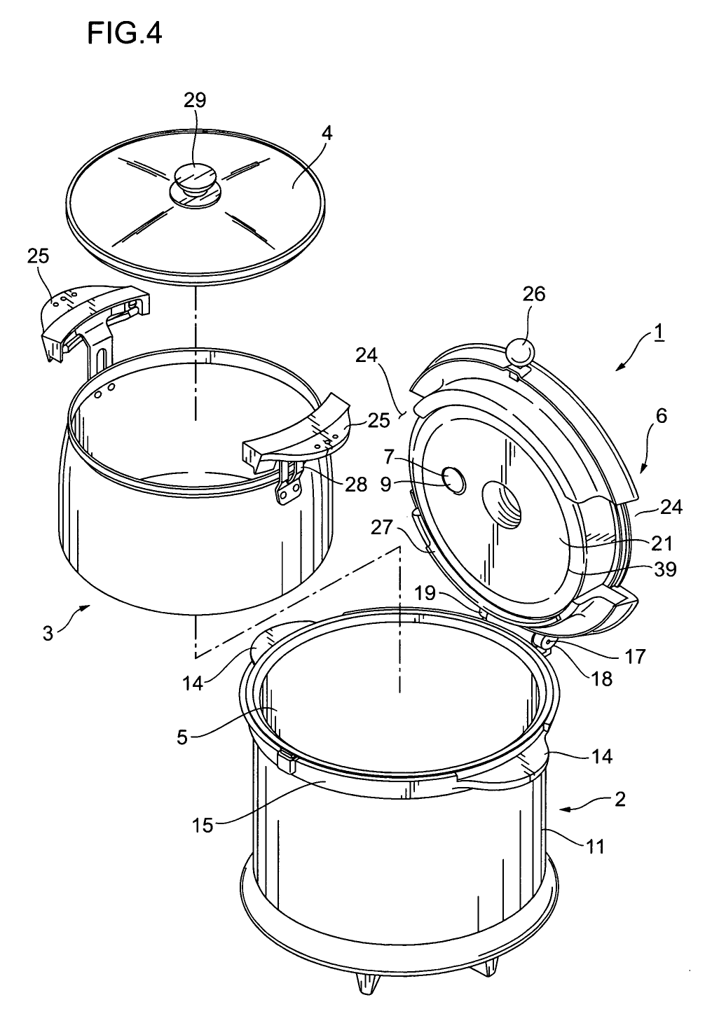

FIGS. 1 to 4 illustrate a heat-insulating cooking container 1 according to a preferred embodiment of the present invention. FIG. 1 is a plan view illustrating the heat-insulating cooking container 1. FIG. 2 is a cross sectional view of the heat-insulating cooking container 1 of FIG. 1 along a line A-A therein. FIG. 3 is a cross sectional view of the heat-insulating cooking container 1 of FIG. 1 along a line B-B therein. FIG. 4 is a view for explaining an assembling process of the heat-insulating container 1.

As illustrated in FIGS. 1 to 4, the heat-insulating cooking container 1 comprises: a heat-insulating outer container 2; an inner container 3 accommodated in the heat-insulating outer container 2; an inner-container cover 4 detachably put on the inner container 3; a heat-insulating-outer-container cover 6 arranged to open or close an aperture portion 5 of the heat-insulating outer container 2; and a thermometer unit 9 installed on the heat-insulating-outer-container cover 6, while it has a temperature-sensing member 7 and a temperature-indicating member 8.

The heat-insulating outer container 2 has the aperture portion 5, while it is provided with an evacuated heat-insulating layer 12 in between an interior-side-container portion 10 made from metal such as stainless steel and an exterior-side-container portion 11, also made from metal such as stainless steel in a manner that it can be structured as a metallic evacuated double-walled container. Moreover, the heat-insulating outer container 2 has a bottom member 13 provided on a bottom portion thereof. Handles 14 for the heat-insulating outer container 2 are provided on both right and left sides of an upper portion thereof. Each handle 14 is integrally molded into a single piece with a shoulder member 15, while the shoulder member 15 is formed in a ring shape and made from synthetic resin forcedly fitted on an upper portion of the periphery of the exterior-side-container portion 11. On a portion of the shoulder member 15 located in a direction perpendicular to a line connecting the pair of handles 14, a hinge base 16 is integrally molded, and a rotation member 18 of the heat-insulating-outer-container cover 6 for closing the aperture portion 5 is rotatably attached to the hinge base 16 via a hinge shaft 17, whereby a hinge 19 is structured by the hinge base 16, the hinge shaft 17, and the rotation member 18.

An upper-surface member 20, which is made from, for instance, polypropylene, is provided on an exterior-surface side of the heat-insulating-outer-container cover 6 so as to define an exterior surface thereof, while a bottom-surface member 21, which is made from, for instance, polypropylene, is provided on an interior-surface side of the heat-insulating-outer-container cover 6 so as to be inserted into the aperture portion 5. A heat-insulating layer 22 made from foamed polystyrene or the like is provided in between the upper-surface member 20 and the bottom-surface member 21. The interior-surface side of the heat-insulating-outer-container cover 6 is formed with an installation hole 23 so as to penetrate this cover 6, while the later-described thermometer unit 9 is installed therein. Both right and left sides of the heat-insulating-outer-container cover 6 are formed with notches 24. The notches 24 operate as communicating members communicated with upwards of the handles 14. Later-described inner-container handles 25 of the inner container 3 are positioned on the notches 24. Moreover, on the opposite side of the hinge base 16 in the heat-insulating-outer-container cover 6, a knob 26 for this cover 6, which is formed in a spherical shape, is provided so as to protrude in a transverse direction thereof.

Meanwhile, a holding member 27 is integrally provided on the interior-surface side of the heat-insulating-outer-container cover 6. The holding member 27 will be explained in detail later.

The inner container 3 is removably accommodated in the heat-insulating outer container 2 and made from metal, such as stainless steel. The inner container 3 has a slightly smaller diameter and depth than those of the heat-insulating outer container 2, while inner-container handles 25 are connected to both right and left sides of an upper portion of the inner container 3 via installation arms 28. Both installation arms 28 are made from metal such as stainless steel. The inner-container handles 25 fixed on leading edges of the installation arms 28 are made from synthetic resin. As explained, the inner-container handles 25 are to be positioned on the notches 24.

The inner-container cover 4, which is removable with respect to the inner container 3, closes an aperture of the inner container 3, while it is made from metal such as stainless steel. Meanwhile, the inner-container cover 4 may be made from glass. On a substantial center of an upper surface of the inner-container cover 4, a knob for this cover is provided in a standing manner.

The thermometer unit 9 is installed in the installation hole 23 penetrating to the interior-surface side of the heat-insulating-outer-container cover 6, it has the temperature-sensing member 7 on the interior-surface side of the heat-insulating-outer-container cover 6, while it has the temperature-indicating member 8 on the exterior-surface side thereof.

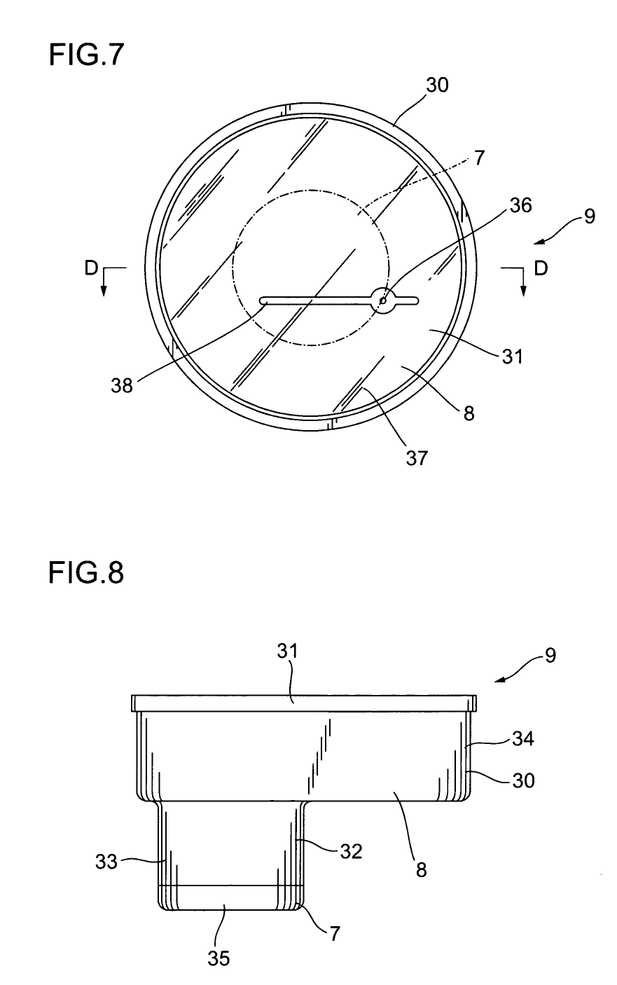

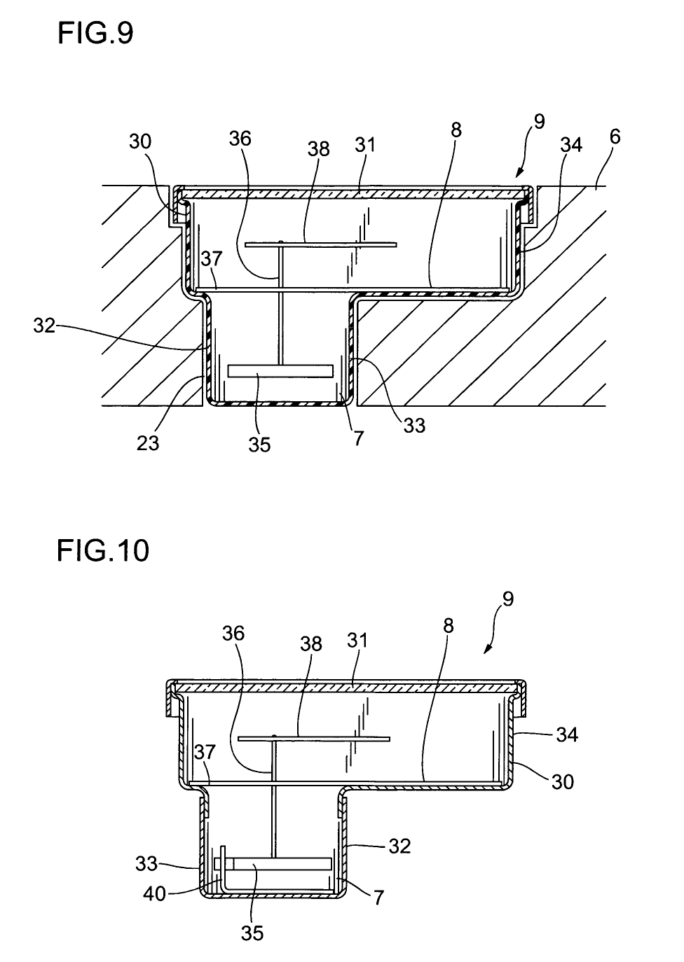

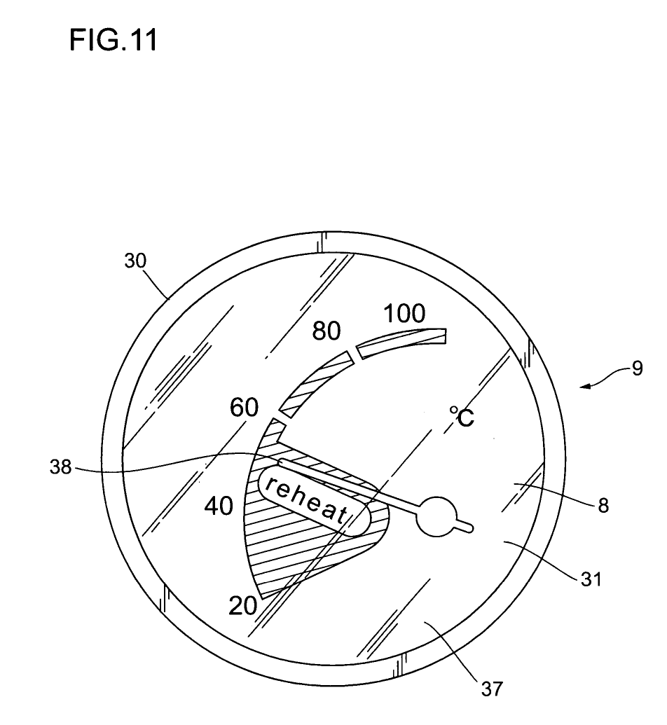

Various embodiments of the thermometer unit 9 are illustrated in FIGS. 7 to 11. FIG. 7 is a plan view illustrating the thermometer unit 9, FIG. 8 is a side view thereof, FIG. 9 is a cross sectional view along a line D-D in FIG. 7, FIG. 10 illustrates a modified embodiment of the thermometer unit 9 of FIG. 9, and FIG. 11 is a detailed view of the temperature-indicating member 8 of the thermometer unit 9.

As illustrated in FIGS. 7 to 11, the thermometer unit 9 according to the embodiments of the present invention comprises: a case 30; the temperature-sensing member 7 provided in the case 30; and the temperature-indicating member 8 for displaying temperature in the interior of the heat-insulating cooking container 1 (temperature at the upward of the inner-container cover 4) detected by the temperature-sensing member 7.

The cover 30 has a front-face portion 31 and a casing portion 32. The front-face portion 31, which is placed on the exterior-surface side of the heat-insulating outer-container cover 6, is transparent, whereby a temperature-display by the temperature-indicating member 8 is made visible from the exterior of the heat-insulating cooking container 1. The casing portion 32 is connected to the front-face portion 31 and reaches the interior-surface side of the heat-insulating-outer-container cover 6. The casing 32 comprises a temperature-sensing-member casing portion 33 accommodating the temperature-sensing member 7 therein, and temperature-indicating-member casing portion 34 accommodating the temperature-indicating member 8 therein. A bottom surface of the temperature-sensing-member casing portion 33 is placed on the upward of the inner-container cover 4 with a slight clearance. Accordingly, when the heat-insulating-outer-container cover 6 is put on the heat-insulating outer container 2, the temperature-sensing-member casing portion 33 is prevented from being collided with the inner-container cover 4. This can make it possible to prevent the inner-container cover 4 from being misaligned relative to the aperture of the inner container 4, steam in the inside of the inner container 3 leak to the inside of the heat-insulating outer container 2, and then the maintaining of temperature in the inner container 3 is disturbed. Moreover, a buffering member such as a packing for buffering when the heat-insulating-outer-container cover 6 collides against the inner-container cover 4 can not be required. As illustrated in FIG. 10, both temperature-sensing-member casing portion 33 and temperature-indicating-member casing portion 34 may be made from metal, each one may be a distinct piece, and these distinct pieces may be joined with each other. In a case that both pieces are made from metal, however, integrally molding two of these pieces into a single piece would be difficult. Accordingly, as illustrated in FIG. 9, when both pieces are made from resin and integrally molded into a single piece, the freedom for the contour of the temperature-sensing-member casing portion 34 can be increased, and thus various types of the temperature-sensing member 7 can be provided therein.

The temperature-sensing member 7 comprises a temperature-sensing-member body 35, and an axis member 36 integrated with the temperature-sensing-member body 35. The temperature-sensing-member body 35 is made from metal, while a bimetallic plate of tabular (structured that two of metal plates having different coefficients of thermal expansion are bonded, and when temperature increases, two of the metal plates bend toward the one having the smaller coefficient of thermal expansion) is used as the temperature-sensing-member body 35. By using the bimetallic plate of tabular, although the temperature-sensing-member casing portion 33 and the temperature-sensing member 7 are not contacted by each other, but a heat-exchanging area thereof can be large, and thus a temperature-detecting performance of the temperature-sensing member 7 can be improved. The axis member 36 turns in accordance with the movement of the temperature-sensing-member body 35. Meanwhile, by providing a thermal-conductive member 40 separately, one end thereof contacting the temperature-sensing-member 33, while the other end thereof being provided on the temperature-sensing-member body 35, temperature-sensing of the temperature-sensing member 7 can be sensitized.

The temperature-indicating member 8 comprises a temperature-indicating panel 37 fixed on a bottom surface of the temperature-indicating-member casing portion 34, and a pointer 38 fixed on an upper end of the axis member 36. As illustrated in FIG. 11, a pattern for displaying temperature is marked on the temperature-indicating panel 37, while an indicator of “reheat” is marked. The pointer 38 turns in accordance with the rotation of axis member 36 which is rotated by the temperature-sensing of the temperature-sensing-member body 35, and thus it indicates temperature. Temperature falling speeds of contents contained in the inner container 3 vary depending on the kinds thereof (for instance, one having rich moisture, containing solids, or the like) and amount thereof, but by indicating “reheat”, a user can decide the necessity of reheat.

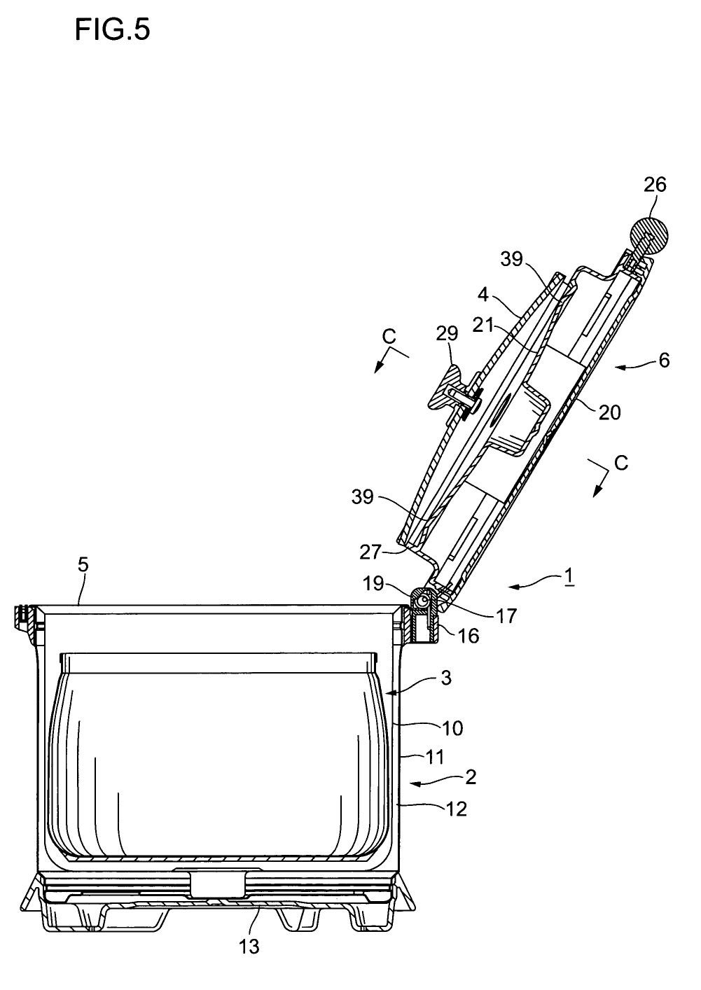

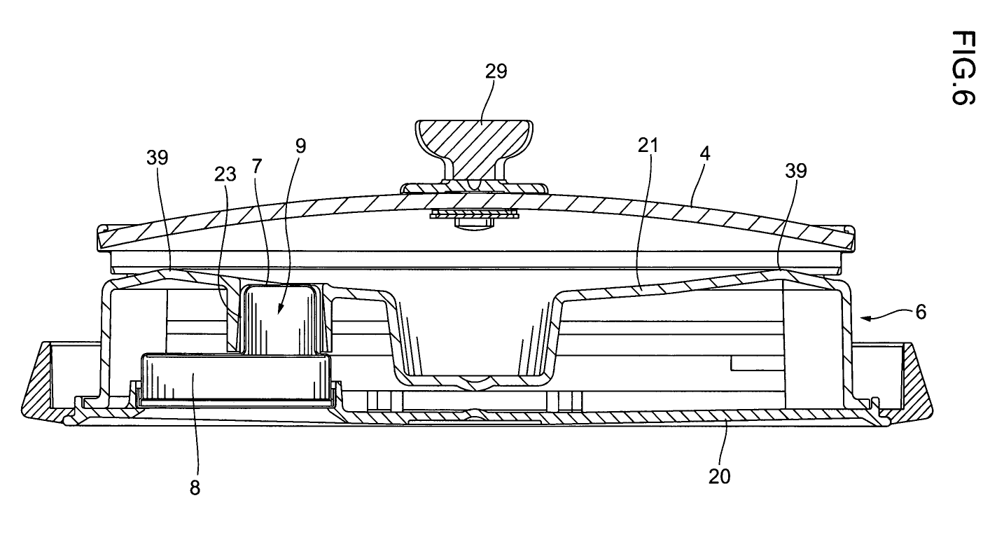

Next, referring to FIGS. 4 to 6, the holding member 27, which is a characteristic part of the heat-insulating cooking container 1 according to the preferred embodiments of the present invention, will now be described. In particular, FIG. 5 is a view illustrating a condition that the inner-container cover 4 is placed on the lifted heat-insulating-outer-container cover 6, and FIG. 6 is a cross sectional view along a line C-C in FIG. 5.

The holding member 27 is integrally provided on the interior surface of the heat-insulating-outer-container cover 6. The holding member 27 is one that holds the inner-container cover 4 so as to allow it to be placed on the interior surface of the heat-insulating-outer-container cover 6 with the temperature-sensing member 7 covered by it when the aperture portion 5 of the heat-insulating outer container 2 is opened by the rotation of the heat-insulating-outer-container cover 6 via the hinge 19.

The holding member 27 is formed in an arc shape, while the inner-container cover 4 is engaged with the inward of the holding member 27. To be more precise, the holding member 27 is provided adjacent to the hinge 19 on the interior surface of the heat-insulating-outer-container cover 6, formed in a hemi-circular shape protruding in a consecutive manner. The holding member 27, however, may not protrude in a consecutive manner, but it can be formed in a hemi-circular shape protruding in an intermittent manner (concavities and convexities are alternately lined).

An interior-surface side of the inner-container cover 4 is formed in a plane shape, or a central portion thereof is concaved toward an upper surface of the inner-container cover 4 with the interior-surface of the heat-insulating-outer-container cover 6 formed in a shape that a central portion thereof is concaved toward the upper surface thereof. Or, the interior-surface side of the inner-container cover 4 is formed in a shape that the central portion thereof is concaved toward the upper surface side with the interior-surface of the heat-insulating-outer-container cover 6 formed in a plane shape. Both covers are structured thus way, whereby a space can be easily provided in between the interior-surface side of the heat-insulating-outer-container cover 6 and inner-container cover 4 when the heat-insulating-outer-container cover 6 is opened so as to open the aperture portion 5 of the heat-insulating outer container 2 by rotating it via the hinge 19, and the inner-container cover 4 is placed on the interior-surface side of the heat-insulating-outer-container cover 6 in a manner that the inner-container-knob 29 provided on the center of the inner-container cover 4 faces up. Moreover, by allowing a bending radius of the bottom-surface member 21 of the heat-insulating-outer-container cover 6 to be larger than that of the inner-container cover 4, a similar space can be provided even if the interior-surface side of the inner-container cover 4 is formed in a shape that the central portion thereof is concaved toward the upper surface side with the central portion of the interior surface of the heat-insulating-outer-container cover 6 concaved toward the upper surface thereof.

Moreover, in a condition that the heat-insulating-outer-container cover 6 is opened and the inner-container cover 4 is provided on the interior surface of the heat-insulating outer container 6, the inner-container-knob 29 is positioned upwardly in a manner that a user can hold the inner-container-knob 29 with his/her fingers from the above thereof, whereby the inner-container cover 4 can be removed from the interior surface of the heat-insulating-outer-container cover 6 without any difficulty.

Further, as illustrated in FIG. 6, a portion of the interior surface of the heat-insulating-outer-container cover 6, which is near the center of the interior surface thereof and against a periphery thereof, protrudes. This portion is hereinafter called a “protrusion portion” 39. In a condition that the inner-container cover 4 is placed on the interior surface of the heat-insulating-outer-container cover 6, the protrusion portion 39 thereof enters an interior-side space of the inner-container cover 4, whereby a displacement of the inner-container cover 4 against the heat-insulating-outer-container cover 6 can be prevented.

Next, operations of the heat-insulating cooking container 1 according to the preferred embodiments of the present invention when used will now be explained in detail.

Food stuffs with an appropriate amount of water or the like are once heated, or the food stuffs and the appropriate amount of water are heated separately, and then put in the inner container 3. A user puts the inner-container cover 4 on the inner container 3, and places the inner container 3 in the heat-insulating outer container 2 while holding the inner-container handles 25. On this occasion, the inner-container handles 25 are placed over the handles 14, while the inner container 3 is held in a suspended condition in a manner providing a slight gap between the interior-side-container portion 10 of the heat-insulating-outer container 2 and it. Next, when the heat-insulating-outer-container cover 6 is put on by rotating it around the hinge shaft 17 as the center of rotation, the handles 14 position in the notches 24 of the heat-insulating-outer-container cover 6, and thus the food stuff can be in an insulated condition for a necessary time, thereby enabling a cooking of the food stuff. When cooking, the temperature-sensing member 7 of the thermometer unit 9 can detect temperature at the upward of the inner-container cover 4, while the temperature-indicating member 8 can indicate that detected temperature. Accordingly, a user can know temperature of the cooking object without lifting the heat-insulating-outer-container cover 6. When a user carries the heat-insulating outer container 2 with the inner container 3, he/she can carry it while grabbing the handles 14. Moreover, he/she can take the inner container 3 from the heat-insulating outer container 2 by lifting the heat-insulating-outer-container cover 6, grabbing the inner-container handles 25, and lifting the inner container 3.

When a user looks at the food stuffs in the inner container 3 after cooking, or allows the heat-insulating cooking container 1 to be in an insulated condition again after taking out some of the food stuffs, operations of the heat-insulating cooking container 1 are the following.

First, the aperture portion 5 of the heat-insulating outer container 2 is opened by rotating the heat-insulating-outer-container cover 6 around the hinge shaft 17 as the center of rotation. Next, the inner-container cover 4 is removed from the inner container 3, and then the inner-container cover 4 is engaged with the holding member 27 provided on the interior-surface side of the heat-insulating-outer-container cover 6, so that the inner-container cover 4 can be placed on the interior-surface side thereof with the inner-container-knob 29 turned upwardly. Accordingly, the temperature-sensing member 7 is prevented from being exposed to the outer air, and thus the lowering of temperature detected by the thermometer unit 9 can be prevented. In a condition that the inner-container cover 4 is placed on the interior surface of the heat-insulating-outer-container cover 6, after a user looks at the food stuffs in the inside of the inner container 3 or takes some of them therefrom, he/she holds the inner-container-knob 29 with his/her fingers, and then put the inner-container cover 4 on the inner container 3. After that, a user put the heat-insulating-outer-container cover 6 on the heat-insulating outer container 2 while holding the knob 26 with his/her fingers, allows the heat-insulating cooking container 1 to be in the insulated condition. In this condition, when the thermometer unit 9 detects temperature in the inside of the heat-insulating cooking container 1, it can detect temperature immediately.

As described, according to the preferred embodiments of the present invention, when the heat-insulating-outer-container cover 6 is lifted and the inner-container cover 4 is placed on the interior surface thereof, the inner-container cover 4 covers the temperature-sensing member 7, whereby the temperature-sensing member 7 can be prevented from being exposed to the outer air. Accordingly, the lowering of temperature detected by the thermometer unit 9 can be prevented. Therefore, when the heat-insulating outer container 2 is re-covered with the heat-insulating-outer-container cover 6 so as to measure temperature, temperature at the space defined by the heat-insulating outer container 2 and its cover 6 can be measured in a short time.

Various embodiments and changes may be made thereonto without departing from the broad spirit and scope of the present invention. The above-described embodiments are intended to illustrate the present invention, not to limit the scope of the present invention. The scope of the present invention is shown by the attached claims rather than the embodiments. Various modifications made within the meaning of an equivalent of the claims of the present invention and within the claims are to be regarded to be in the scope of the present invention.

1. A heat-insulating cooking container comprising a heat-insulating outer container and an inner container having an inner-container cover, said inner container being accommodated in said heat-insulating outer container, an aperture portion of said heat-insulating outer container being openably and closably covered by a heat-insulating-outer-container cover, wherein:
a thermometer unit is installed on said heat-insulating-outer-container cover;
a temperature-sensing member of said thermometer unit is located on an interior-surface side of said heat-insulating-outer-container cover; and
said inner-container cover covers said temperature-sensing member upon opening said heat-insulating-outer-container cover and placing said inner-container cover on an interior surface of said heat-insulating-outer-container cover.

2. The heat-insulating cooking container according to claim 1, wherein:
a holding member is provided on the interior surface of said heat-insulating-outer-container cover; and
said inner-container cover is placed on the interior surface of said heat-insulating-outer-container cover with said holding member used.

3. The heat-insulating cooking container according to claim 2, wherein said holding member is formed in an arc shape, an interior side thereof being to be engaged with said inner-container cover.

4. The heat-insulating cooking container according to claim 1, wherein a space is provided in between the interior surface of said heat-insulating-outer-container cover and said inner-container cover upon opening said heat-insulating-outer-container cover and placing said inner-container cover on the interior surface of said heat-insulating-outer-container cover.

5. The heat-insulating cooking container according to claim 2, wherein a space is provided in between the interior surface of said heat-insulating-outer-container cover and said inner-container cover upon opening said heat-insulating-outer-container cover and placing said inner-container cover on the interior surface of said heat-insulating-outer-container cover.

6. The heat-insulating cooking container according to claim 3, wherein a space is provided in between the interior surface of said heat-insulating-outer-container cover and said inner-container cover upon opening said heat-insulating-outer-container cover and placing said inner-container cover on the interior surface of said heat-insulating-outer-container cover.

7. The heat-insulating cooking container according to claim 4, wherein the interior surface of said inner-container cover is formed in a plane shape, or a central portion thereof is concaved toward an upper surface thereof with the interior surface of said heat-insulating-outer-container cover formed in a shape that a central portion thereof is concaved toward the upper surface thereof, or, the interior surface of said inner-container cover is formed in a shape that the central portion thereof is concaved toward the upper surface thereof with the interior surface of the heat-insulating-outer-container cover formed in a plane shape.

8. The heat-insulating cooking container according to claim 5, wherein the interior surface of said inner-container cover is formed in a plane shape, or a central portion thereof is concaved toward an upper surface thereof with the interior surface of said heat-insulating-outer-container cover formed in a shape that a central portion thereof is concaved toward the upper surface thereof, or, the interior surface of said inner-container cover is formed in a shape that the central portion thereof is concaved toward the upper surface thereof with the interior surface of the heat-insulating-outer-container cover formed in a plane shape.

9. The heat-insulating cooking container according to claim 6, wherein the interior surface of said inner-container cover is formed in a plane shape, or a central portion thereof is concaved toward an upper surface thereof with the interior surface of said heat-insulating-outer-container cover formed in a shape that a central portion thereof is concaved toward the upper surface thereof, or, the interior surface of said inner-container cover is formed in a shape that the central portion thereof is concaved toward the upper surface thereof with the interior surface of the heat-insulating-outer-container cover formed in a plane shape.

10. The heat-insulating cooking container according to claim 1, wherein:
a knob is provided on an upper surface of said inner-container cover; and
said knob is positioned upwardly in a manner that said knob is enabled to be held from an above thereof with a user's fingers upon opening said heat-insulating-outer-container cover and placing said inner-container cover on the interior surface of said heat-insulating-outer-container cover.

11. The heat-insulating cooking container according to claim 2, wherein:
a knob is provided on an upper surface of said inner-container cover; and
said knob is positioned upwardly in a manner that said knob is enabled to be held from an above thereof with a user's fingers upon opening said heat-insulating-outer-container cover and placing said inner-container cover on the interior surface of said heat-insulating-outer-container cover.

12. The heat-insulating cooking container according to claim 3, wherein:
a knob is provided on an upper surface of said inner-container cover; and
said knob is positioned upwardly in a manner that said knob is enabled to be held from an above thereof with a user's fingers upon opening said heat-insulating-outer-container cover and placing said inner-container cover on the interior surface of said heat-insulating-outer-container cover.

13. The heat-insulating cooking container according to claim 4, wherein:
a knob is provided on an upper surface of said inner-container cover; and
said knob is positioned upwardly in a manner that said knob is enabled to be held from an above thereof with a user's fingers upon opening said heat-insulating-outer-container cover and placing said inner-container cover on the interior surface of said heat-insulating-outer-container cover.

14. The heat-insulating cooking container according to claim 5, wherein:
a knob is provided on an upper surface of said inner-container cover; and
said knob is positioned upwardly in a manner that said knob is enabled to be held from an above thereof with a user's fingers upon opening said heat-insulating-outer-container cover and placing said inner-container cover on the interior surface of said heat-insulating-outer-container cover.

15. The heat-insulating cooking container according to claim 6, wherein:
a knob is provided on an upper surface of said inner-container cover; and
said knob is positioned upwardly in a manner that said knob is enabled to be held from an above thereof with a user's fingers upon opening said heat-insulating-outer-container cover and placing said inner-container cover on the interior surface of said heat-insulating-outer-container cover.

16. The heat-insulating cooking container according to claim 7, wherein:
a knob is provided on an upper surface of said inner-container cover; and
said knob is positioned upwardly in a manner that said knob is enabled to be held from an above thereof with a user's fingers upon opening said heat-insulating-outer-container cover and placing said inner-container cover on the interior surface of said heat-insulating-outer-container cover.

17. The heat-insulating cooking container according to claim 8, wherein:
a knob is provided on an upper surface of said inner-container cover; and
said knob is positioned upwardly in a manner that said knob is enabled to be held from an above thereof with a user's fingers upon opening said heat-insulating-outer-container cover and placing said inner-container cover on the interior surface of said heat-insulating-outer-container cover.

18. The heat-insulating cooking container according to claim 9, wherein:
a knob is provided on an upper surface of said inner-container cover; and
said knob is positioned upwardly in a manner that said knob is enabled to be held from an above thereof with a user's fingers upon opening said heat-insulating-outer-container cover and placing said inner-container cover on the interior surface of said heat-insulating-outer-container cover.
